(19) United States
(12) Patent Application Publication
(10) Pub. No.: US 2009/0166311 A1
(43) Pub. Date: Jul. 2, 2009

(54) Pharmaceutical closure with a laser-applied marking

(75) Inventor: Albert Louis Victor Jozef Claessens, Houthalen (BE)

Correspondence Address: COLLARD & ROE, P.C., 1077 NORTHERN BOULEVARD, ROSLYN, NY, 11576, US

(73) Assignee: Helvoet Pharma Belgium N.V.

(21) Appl. No.: 12/005,459

(22) Filed: Dec. 27, 2007

(51) Int. Cl. A61J 1/18; B65D 51/22; B29C 70/80

(52) U.S. Cl. 215/203; 215/247; 264/482; 264/268

(57) ABSTRACT

A pharmaceutical closure is made from rubber or thermoplastic elastomer and has an amount of TiO₂ present in the closure. The closure has a marking made by laser thereon. A method for manufacturing the closure consists of producing a rubber sheet, forming a plurality of closures on the rubber sheet, with the closures remaining integrally connected with each other through remaining sheet parts, marking each of the closures with a laser marking, and separating the closures from each other by punching.

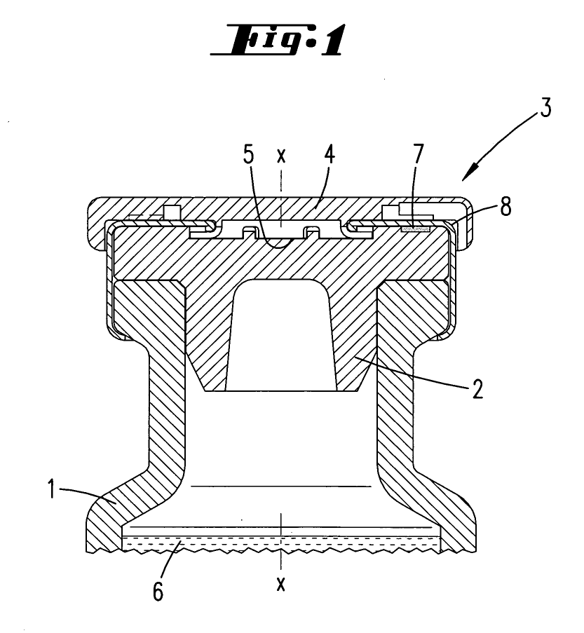

### BACKGROUND OF THE INVENTION

1. Field of the Invention

The invention relates to the use of marking applied by laser on a pharmaceutical closure made from rubber or a thermoplastic elastomer (TPE). Further, the invention is concerned with such pharmaceutical closures and a method of making such closures.

2. The Prior Art

Pharmaceutical closures as mentioned before are already widely known. For example, such closures are described in European Patent Nos. EP 0 322 547, EP 1 010 635, and U.S. Pat. No. 6,241,112.

Such closures can be used on a vial or a syringe or other articles such as so-called bottle packs. All of these closures are in direct contact with a pharmaceutical substance over an extended period of time. Also, they can be in form of a protective cap for a needle, as for example disclosed in U.S. Pat. No. 6,000,580. In general, it can be a closure for or a closure part as such or for a receptacle or an instrument used for parental medicine.

### SUMMARY OF THE INVENTION

There is a desire to have a clear indication on whether such closure is an authorized product by a producer and maybe also in terms of other information such as when it has been produced and where, for example in which factory. On the other hand, pharmaceutical articles need to be produced very carefully. They must not contain any matter which could bring harm to a person for which a medicine contained in such receptacle as a vial or syringe, sealed with such article, is used.

Based on this, invention provides a laser marking which changes the structure of TiO₂ contained in the article such that on a surface of such article an image is created. The image can be a trade name or a logo or a series of digits, etc. It has been discovered that it is possible to have such pharmaceutical articles based on rubber or a thermoplastic elastomer with an amount of TiO₂, wherein at least in a surface of the article, TiO₂ is present in such an amount that it can be influenced by the laser in terms of making the mentioned image. TiO₂, titanium dioxide, is a substance which is useable in pharmaceutical articles without any restriction. The TiO₂ is preferably homogenously distributed in the article. It has been demonstrated in laboratory tests that the laser-marking on stoppers does not have an influence on the quality of the stopper.

Such stoppers are usually made from a pharmaceutical rubber. A halobutyl rubber such as chlorobutyl rubber or bromobutyl rubber is preferred.

The table below gives an overview of tests according to Japanese Pharmacopeia. As samples, pharmaceutical stoppers have been used. In the test, a non-marked sample of a commercial high quality rubber grade is compared to 2 samples in the same rubber grade but with a 60% and 80% intensity laser-marking over the entire surface of the sample. A normal text marking would only cover <5% of the closure surface. Nevertheless these completely marked samples are fully compliant to the Japanese pharmacopeia. Tests are performed according to Japanese Pharmacopoeia 14^{th} Ed., Part 1, Chapter 59 “Rubber Closures for Aqueous Infusions”.

| | | | | 2 | 3 |
|---|---|---|---|---|---|
| | | | 1 | bromobutyl | bromobutyl |
| | | | Bromobutyl | 60% laser | 80% laser |
| Criterium | Units | Limit | no marking | marking | marking |
| Appearance | % T at 430 nm | >=99.0 | 99.8 | 99.7 | 99.8 |
| (430/650 nm) | % T at 650 nm | >=99.0 | 99.9 | 99.8 | 99.7 |
| Foam Test | — | foam | pass | pass | pass |
| | | disappears | | | |
| | | within 3 min | | | |
| pH | pH-unit | difference | 0.1 | 0.5 | 0.5 |
| | | with blank | | | |
| | | max 1.0 | | | |
| Reducing | ml 0.002 M | 2 | 0.7 | 1.0 | 1.0 |
| Substances | KMnO₄ | | | | |
| Evaporation | mg | 2 | 0.2 | 0.5 | 0.4 |
| Residue | | | | | |
| UV | absorbance | 0.2 | 0.033 | 0.052 | 0.045 |
| absorption | | | | | |
| (220-350 nm) | | | | | |
| Zinc | ppm Zn²⁺ | 1 | 0.00 | 0.01 | 0.01 |

It is preferred, to use a Nd:YVO₄ laser. The wave length of the laser is preferred in the range <400 nanometer (nm) especially 350 nm, even more preferably 355 nm.

In a preferred embodiment, the closure consists of a thermoplastic elastomer, such as described in European Patent Nos. EP 1 192 092 B1 and EP 1 400 458 B1, both of which are herein incorporated by reference.

Pharmaceutical parts in the form of closures, also sometimes referred to as stoppers, have a region of reduced thickness related to its upper surface, and an injection area within this region. In one embodiment, the marking made with the laser in the above-described manner, is preferably made outside of the injection area. As an alternative, it can also be provided inside the injection area. The injection area is the part of the pharmaceutical part which is open for inspection at the time of injecting, for example a needle. In case the marking is in this area, the user can confirm for himself that he is using a correct article.

It is also preferred to have the marking on a pharmaceutical closure for a vial, which is covered by a protection cap. This is described, for example, in U.S. Pat. No. 6,868,978 B2. Such a protection cap has either an inner opening or a (separate) cover part, which can be torn off or in any other way taken away, such that a central region of the closure gets exposed. With this embodiment, it is preferred that the marking is on an area of the closure that is also covered in use by the protection cap. On the other hand, the marking is preferred to be on an upper surface of the closure, so that in case the remaining part of the protection cap is removed, one can easily inspect the marking.

Generally, pharmaceutical rubber closures are compression molded. The stoppers are molded on sheets containing multiple closures. The closures are subsequently punched from the sheet. As a last process, the rubber closures are washed and eventually siliconized. In a preferred embodiment, the marking is applied on the closures while they are still on the sheets. This way, the quality of the print is not affected by the lubricant used in the punching process. Also, the quality of the final siliconization is not affected by the lasermarking.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

The drawing shows in a cross section a vial having a closure, and the closure covered by a protection cap.

### DETAILED DESCRIPTION OF THE PREFERRED EMBODIMENT

With reference to the FIGURE, there is shown part of a vial 1 with a closure 2, being a stopper. Closure 2 consists of a pharmaceutical rubber grade.

Closure 2 is covered by a protection cap 3 which has an upper opening part 4, which can be removed for using the medicine contained in the vial.

Once upper part 4 is removed, upper middle surface 5 of closure 2 is exposed. One can thereupon inject through closure 2 a needle for removing medicine 6 contained in vial 1.

Further, closure 2 has a marking 7 on its upper surface 5, but in a region of surface 5 being still covered by the remaining part 8 of protection cap 3 after part 4 has been removed.

Only for the purpose of showing the marking in the drawings, it has been extended in the cross section to some extent below the surface. In practice, the layer in which the marking, performed by changing of the TiO₂, will be very thin, in the micrometer range.

Accordingly, while only a few embodiments of the present invention have been shown and described, it is obvious that many changes and modifications may be made thereunto without departing from the spirit and scope of the invention.

What is claimed is:

1. A pharmaceutical closure made from rubber or thermoplastic elastomer and having an amount of TiO₂ present in the closure, wherein the closure has a marking made by laser thereon.

2. A pharmaceutical closure according to claim 1, wherein the closure is for a receptacle or an instrument used for a parenteral drug.

3. A pharmaceutical closure according to claim 1, wherein the marking is made in an upper surface of the closure when the closure is in use.

4. A pharmaceutical closure according to claim 3, wherein the upper surface has a region of reduced thickness and an injection area within said region of reduced thickness, and wherein the marking is provided outside of the injection area.

5. A pharmaceutical closure according to claim 3, wherein the upper surface has a region of reduced thickness and an injection area within said region of reduced thickness, and wherein the marking is provided inside of the injection area.

6. A pharmaceutical closure according to claim 1, further comprising a protection cap covering the closure and having an opening that allows penetration of the closure with a needle, wherein the marking is also covered by the protection cap.

7. A method for manufacturing pharmaceutical closures made from rubber having an amount of TiO₂, comprising the following steps:
producing a rubber sheet;
forming a plurality of closures on the rubber sheet, said closures remaining integrally connected with each other through remaining sheet parts;
marking each of the closures with a laser marking; and
separating the closures from each other by punching.

8. A method according to claim 7, wherein the separated closures are washed.

9. A method according to claim 7, wherein the separated closures are siliconized.
